(19) United States
(12) Patent Application Publication
(10) Pub. No.: US 2026/0006132 A1
(43) Pub. Date: Jan. 1, 2026

(54) APPARATUS, SYSTEM, AND METHODS FOR ENHANCING EMERGENCY MAPPING AND COMPUTER-AIDED-DISPATCH INCIDENT CREATION AND UPDATES FOR EMERGENCY SERVICE NETWORKS

(71) Applicant: RAPIDSOS, INC., New York, NY (US)

(72) Inventors: John Robert Katt, New York, NY (US); James Patrick Olejar, Fort Lauderdale, FL (US)

(21) Appl. No.: 18/759,954

(22) Filed: Jun. 30, 2024

(51) Int. Cl. H04M 11/04; H04L 67/12

(52) U.S. Cl. CPC H04M 11/04; H04L 67/12

(57) ABSTRACT

A disclosed method implements training an artificial intelligence module in a cloud-based emergency data management system using training data comprising emergency call data from an emergency communication center (ECC); generating a script, in response to the training data, by the artificial intelligence module, the script for converting emergency call data into a mapping subprocess format of the cloud-based emergency data management system; and configuring a cloud-based processor using the script.

### CROSS-REFERENCE TO RELATED APPLICATIONS

None.

### FIELD OF THE DISCLOSURE

The present disclosure relates generally to enhanced 9-1-1 (E911) and next generation 9-1-1 (NG911) emergency networks and more particularly to methods, apparatuses, and systems that assist in understanding and responding to emergencies by emergency communications centers (ECCs) utilizing such emergency networks.

### BACKGROUND

The evolution of emergency networks toward achieving full enhanced 9-1-1 (E911) and next generation 9-1-1 (NG911) capabilities has been arduous. Currently, most emergency networks remain a conglomeration of legacy 9-1-1 telecommunications equipment and added in components to begin creating full enhanced and next generation capabilities.

Emergency networks involve an Emergency Communication Center (ECC) which is defined by the National Emergency Number Association (NENA) as “A set of call takers operating under common management which receives emergency calls for service and asynchronous event notifications and processes those calls and events according to a specified operational policy.” A specific type of ECC is a Public Safety Answering Point (PSAP) which NENA defines as an entity responsible for receiving 9-1-1 calls and processing those calls according to a specific operational policy.

ECC call takers benefit from various software systems including call handling and call taking software, computer-aided-dispatch (CAD) systems and the like. As ECCs evolve toward advanced capabilities, new requirements for data flow in and out of the ECCs has also become a consideration.

### BRIEF DESCRIPTION OF THE DRAWINGS

FIG. 1 is a block diagram of a machine learning training scheme for an artificial intelligence (AI) module of an emergency data management system, in accordance with an embodiment.

FIG. 2 is a block diagram of another machine learning training scheme for an AI module of an emergency data management system, in accordance with an embodiment.

FIG. 3 is a block diagram of an Emergency Communication Center (ECC) that is in communication with a cloud-based, software-as-a-service (SaaS) emergency data management system (EDMS) that implements an ECC script generated by machine learning using the AI module and machine learning training scheme as shown and described with respect to FIG. 1, in accordance with an embodiment. The ECC may be a Public Safety Answering Point (PSAP).

FIG. 4 is a block diagram of an Emergency Communication Center (ECC) that includes a computer-aided-dispatch (CAD) screened network, that is in communication with a cloud-based, software-as-a-service (SaaS) emergency data management system (EDMS), that implements an ECC script generated by machine learning using the AI module and machine learning training scheme as shown and described with respect to FIG. 2, in accordance with an embodiment. The ECC may be a Public Safety Answering Point (PSAP).

FIG. 5 is a flowchart of a method of operation for machine learning training in accordance with an embodiment corresponding to FIG. 1.

FIG. 6 is a is a flowchart of a method of operation or machine learning training in accordance with an embodiment corresponding to FIG. 2.

FIG. 7 is a flowchart of a method of operation for machine learning training in accordance with an embodiment corresponding to FIG. 1.

FIG. 8 is a is a flowchart of a method of operation or machine learning training in accordance with an embodiment corresponding to FIG. 2.

FIG. 9 is a is a flowchart of a method of operation for sending emergency data to an ECC CAD system in accordance with an embodiment corresponding to FIG. 3.

FIG. 10 is a flowchart of a method of operation for sending emergency data to an ECC CAD system in accordance with an embodiment corresponding to FIG. 4.

### DETAILED DESCRIPTION

Briefly, the present disclosure provides apparatuses, systems, and methods, engineered using machine learning, that provide an advanced data view and information to call takers, dispatchers, or both, at an emergency communications center (ECC). One example ECC is a public safety access point (PSAP) that receives and responds to 9-1-1 emergency calls, and dispatches responders such as, but not limited to, police, fire department, and paramedics. Cloud-based processors are configured using machine learning generated code (scripts) that are used by subprocesses to provide the advanced data view and updates. The disclosed apparatuses, systems, and methods, include a cloud-based emergency management system that provides an enhanced emergency mapping that is enhanced using data that would otherwise only be provided to the computer-aided-dispatch system from a call handling system. The disclosed apparatuses, systems, and methods also provide for creation of CAD incident records directly from emergency alert systems and also updating CAD incident records with supplemental emergency data that would not otherwise be available to the CAD system.

In one aspect, a method implements: training an artificial intelligence module in a cloud-based emergency data management system using training data comprising emergency call data from an emergency communication center (ECC); generating a script, in response to the training data, by the artificial intelligence module, the script for converting emergency call data into a mapping subprocess format of the cloud-based emergency data management system; and configuring a cloud-based processor using the script.

The method may further implement: training the artificial intelligence module using training data comprising serial text data. The method may further implement training the artificial intelligence module using ANI/ALI (Automatic Number Identification/Automatic Location Identification) data. The method may further implement training the artificial intelligence module using AVL (Automatic Vehicle Location) data. The method may further implement training the artificial intelligence module using call handling data. The method may further implement training the artificial intelligence module to identify each class of service in the training data. The method may further implement training the artificial intelligence module to identify each data field type in the training data.

In another aspect, a method implements: obtaining emergency data related to an emergency call to an emergency communication center (ECC) by a connectivity device operatively coupled to a functional entity of the ECC; sending the emergency data to a processor of the cloud-based emergency data management system; converting the emergency data, by the processor, into a data object; processing the data object by a mapping subprocess of a cloud-based application hosted by the cloud-based emergency data management system; and updating a map view of an instance of the cloud-based application, executed on a computer located at the ECC, using the data object.

The method may further implement obtaining serial text data via a serial port connection between the connectivity device and the functional entity. The method may further implement obtaining ANI/ALI (Automatic Number Identification/Automatic Location Identification) data from the functional entity by the connectivity device. The method may further implement obtaining AVL (Automatic Vehicle Location) data from the functional entity by the connectivity device. The method may further implement obtaining call handling data from the functional entity by the connectivity device. The method may further implement executing a machine learning generated script by the processor, to convert the emergency data into the data object. The method may further implement converting the emergency data, by the processor, into a javascript object notation (JSON) data object. The method may further implement converting the emergency data, by the processor, into an emergency incident data object (EIDO). The method may further implement executing a machine learning generated script by the processor, to convert the emergency data into a javascript object notation (JSON) data object. The method may further implement executing a machine learning generated script by the processor, to convert the emergency data into an emergency incident data object (EIDO).

In another aspect, a system includes: a connectivity device with at least one processor and a non-volatile, non-transitory memory, operatively coupled to the processor. The connectivity device is physically located at an emergency communication center (ECC), and is operatively coupled to an ECC functional entity, and a cloud-based emergency data management system. The connectivity device is operative to receive emergency call data from the ECC functional entity. The cloud-based emergency data management system includes: at least a first cloud-based processor and a second cloud-based processor. The first cloud-based processor and the second cloud-based processor are operatively coupled. The first cloud-based processor is operative to: receive the emergency call data from the connectivity device; convert the emergency call data into a data object; and send the data object to the second cloud-based processor. The second cloud-based processor is operative to: receive the data object from the first cloud-based processor: process the data object by a mapping subprocess of a cloud-based application executed by the second cloud-based processor; and update a map view of an instance of the cloud-based application, executed on a computer located at the ECC, using the data object.

The system may be further operative to receive the emergency call data as serial text data via a serial port connection between the connectivity device and the ECC functional entity. The system may be further operative to receive the emergency call data as ANI/ALI (Automatic Number Identification/Automatic Location Identification) data from the ECC functional entity. The system may be further operative to receive AVL (Automatic Vehicle Location) data from the ECC functional entity. The system may be further operative to receive call handling data from the ECC functional entity. The system may be further operative to execute a machine learning generated script to convert the emergency call data into the data object. The system may be further operative to execute a machine learning generated script to convert the emergency call data into a javascript object notation (JSON) data object. The system may be further operative to execute a machine learning generated script to convert the emergency call data into an emergency incident data object (EIDO).

In another aspect of the present disclosure, a disclosed method of training an artificial intelligence module for machine learning includes: providing training data with emergency call data from an emergency communication center (ECC) to an artificial intelligence module in a cloud-based emergency data management system; providing machine learning instructions to the artificial intelligence module, instructing the artificial intelligence module to generate a script for converting emergency call data into a format usable by a mapping subprocess of the cloud-based emergency data management system; and obtaining the script generated by the AI module in response to the machine learning instructions and the training data.

Providing training data with emergency call data from an emergency communication center (ECC) may further include providing serial text data. Providing training data may further include providing ANI/ALI (Automatic Number Identification/Automatic Location Identification) data. Providing training data may further include providing AVL (Automatic Vehicle Location) data. Providing training data may further include providing call handling data.

Providing machine learning instructions to the artificial intelligence module, may further include instructing the artificial intelligence module to identify each class of service in the training data. Providing machine learning instructions to the artificial intelligence module may include instructing the artificial intelligence module to identify each data field type in the training data.

In another aspect of the present disclosure, a method of training an artificial intelligence module for machine learning includes: providing training data with emergency call data from an emergency communication center (ECC) to an artificial intelligence module in a cloud-based emergency data management system; providing machine learning instructions to the artificial intelligence module, instructing the artificial intelligence module to generate a script for converting emergency alerts data into a format usable by a computer-aided-dispatch (CAD) system of the ECC; and generating the script by the AI module in response to the machine learning instructions and using the training data.

Providing training data with emergency call data from an emergency communication center (ECC) may further include providing serial text data. Providing training data may further include providing ANI/ALI (Automatic Number Identification/Automatic Location Identification) data.

Providing machine learning instructions to the artificial intelligence module may include instructing the artificial intelligence module to identify each class of service in the training data. Providing machine learning instructions may include instructing the artificial intelligence module to identify each data field type in the training data. Providing machine learning instructions to the artificial intelligence module may further include instructing the artificial intelligence module to identify a class of service in the training data having the largest data payload. Providing machine learning instructions to the artificial intelligence module may further include instructing the artificial intelligence module to identify a class of service in the training data having the largest number of data fields. Providing machine learning instructions to the artificial intelligence module may further include instructing the artificial intelligence module to generate a script to fit emergency alert data into a class of service that has the largest number of data fields. Providing machine learning instructions may further include instructing the artificial intelligence module to generate a script to fit emergency alert data into a class of service that has the largest data payload.

In another aspect of the present disclosure, a method of operating a cloud-based emergency data management system includes: obtaining emergency data related to an emergency call to an emergency communication center (ECC) by a connectivity device operatively coupled to a functional entity of the ECC; sending the emergency data to a processor of the cloud-based emergency data management system; converting the emergency data, by the processor, into a data object; processing the data object by a mapping subprocess of a cloud-based application hosted by the cloud-based emergency data management system; and displaying the emergency data within a graphical user interface (GUI) representing an instance of the cloud-based application running on a computer located at the ECC.

Obtaining emergency data related to an emergency call to an emergency communication center (ECC) by a connectivity device operatively coupled to a functional entity of the ECC may further include obtaining serial text data. Obtaining emergency data related to an emergency call may further include obtaining ANI/ALI (Automatic Number Identification/Automatic Location Identification) data. Obtaining emergency data related to an emergency call may further include obtaining AVL (Automatic Vehicle Location) data. Obtaining emergency data may further include obtaining call handling data.

Converting the emergency data, by the processor, into a data object, may further include: executing a machine learning generated script by the processor, to convert the emergency data into the data object. Converting the emergency data, by the processor, into a data object may further include: converting the emergency data, by the processor, into a javascript object notation (JSON) data object. Converting the emergency data, by the processor, into a data object may further include: converting the emergency data, by the processor, into an emergency incident data object (EIDO). Converting the emergency data into a data object may further include executing a machine learning generated script by the processor, to convert the emergency data into a javascript object notation (JSON) data object. Converting the emergency data into a data object may further include executing a machine learning generated script by the processor, to convert the emergency data into an emergency incident data object (EIDO).

In another aspect of the present disclosure, a system includes: a connectivity device, with at least one processor and a non-volatile, and non-transitory memory that is operatively coupled to the processor. The connectivity device is located at an emergency communication center (ECC) and is operatively coupled to an ECC functional entity, and a cloud-based emergency data management system. The connectivity device is operative to receive emergency call data from the ECC functional entity. The cloud-based emergency data management system includes: at least a first processor and a second processor. The first and second processor are operatively coupled. The first processor is operative to: receive the emergency call data from the connectivity device; convert the emergency call data into a data object; and send the data object to the second processor. The second processor is operative to: receive the data object from the first processor; provide the data object to a mapping subprocess of a cloud-based application executed by the first processor; and display the emergency call data within a graphical user interface (GUI) representing an instance of the cloud-based application running on a computer located at the ECC.

The connectivity device may be further operative to receive the emergency call data as serial text data. The connectivity device may be further operative to receive the emergency call data as ANI/ALI (Automatic Number Identification/Automatic Location Identification) data. The connectivity device may be further operative to receive AVL (Automatic Vehicle Location) data. The connectivity device may be further operative to receive call handling data.

The first processor may be further operative to execute a machine learning generated script to convert the emergency call data into the data object. The first processor may be further operative to execute a machine learning generated script to convert the emergency call data into a javascript object notation (JSON) data object. The first processor may be further operative to execute a machine learning generated script to convert the emergency call data into an emergency incident data object (EIDO).

In another aspect of the present disclosure, a method of operating a cloud-based emergency data management system includes: receiving emergency alert data at a cloud-based emergency data management system; converting the emergency alert data into ANI/ALI (Automatic Number Identification/Automatic Location Identification) formatted data; sending the ANI/ALI formatted data to a connectivity device located at an emergency communication center (ECC), over an internet protocol connection between the cloud-based emergency data management system and the connectivity device, wherein the connectivity device is operatively coupled to a functional entity of the ECC; and sending the ANI/ALI formatted data from the connectivity device located at the emergency communication center (ECC) to a computer-aided-dispatch (CAD) system located at the ECC, such that the ANI/ALI formatted data appears to the CAD system as ANI/ALI data from an ECC functional entity that provides an ANI/ALI feed.

Obtaining emergency alert data, may further include obtaining home security alarm data, fire alarm data, and medical bracelet alarm data. Sending the ANI/ALI formatted data from the connectivity device located at the emergency communication center (ECC) to a computer-aided-dispatch (CAD) system located at the ECC may further include sending the ANI/ALI data as serial text data. Sending the ANI/ALI formatted data may further include sending the ANI/ALI formatted data over a transmission control protocol (TCP) connection between the connectivity device and the CAD system.

Converting the emergency alert data into ANI/ALI formatted data may further include executing a machine learning generated script, to convert the emergency alert data into ANI/ALI formatted data. Converting the emergency alert data may further include formatting the emergency alert data according to a specific class of service.

Formatting the emergency alert data according to a specific class of service may further include formatting the emergency alert data according to a voice-over-IP (VOIP) class of service. Formatting the emergency alert data according to a voice-over-IP (VOIP) class of service may further include executing a machine learning generated script to format the emergency alert data. The method may further include establishing a virtual private network connection between the connectivity device located at the ECC, and a screened network of the ECC comprising the CAD system.

In another aspect of the present disclosure, a cloud-based emergency data management system includes: a connectivity device, with at least one processor and a non-volatile, non-transitory memory that is operatively coupled to the processor. The connectivity device is located at an emergency communication center (ECC), and is operatively coupled to an ECC functional entity, an ECC computer-aided-dispatch (CAD) system, and a first processor of the cloud-based emergency data management system. A second processor is operatively coupled to the first processor. The second processor is operative to receive emergency alert data and send the emergency alert data to the first processor. The first processor is operative to: receive the emergency alert data from the second processor; convert the emergency alert data into ANI/ALI (Automatic Number Identification/Automatic Location Identification) formatted data; and send the ANI/ALI formatted data to the connectivity device. The connectivity device is operative to send the ANI/ALI formatted data to the CAD system located at the ECC, such that the ANI/ALI formatted data appears to the CAD system as ANI/ALI data from the ECC functional entity.

The second processor may be further operative to receive emergency alert data such as, but not limited to, home security alarm data, fire alarm data, and medical bracelet alarm data. The connectivity device may be further operative to send the ANI/ALI data as serial text data. The connectivity device may be further operative to send the ANI/ALI formatted data over a transmission control protocol (TCP) connection between the connectivity device and the CAD system. The first processor may be further operative to execute a machine learning generated script, to convert the emergency alert data into ANI/ALI formatted data. The first processor may be further operative to format the emergency alert data according to a specific class of service. The first processor may be further operative to format the emergency alert data according to a voice-over-IP (VOIP) class of service. The connectivity device may be further operative to establish a virtual private network connection between the connectivity device located at the ECC, and a screened network of the ECC comprising the CAD system.

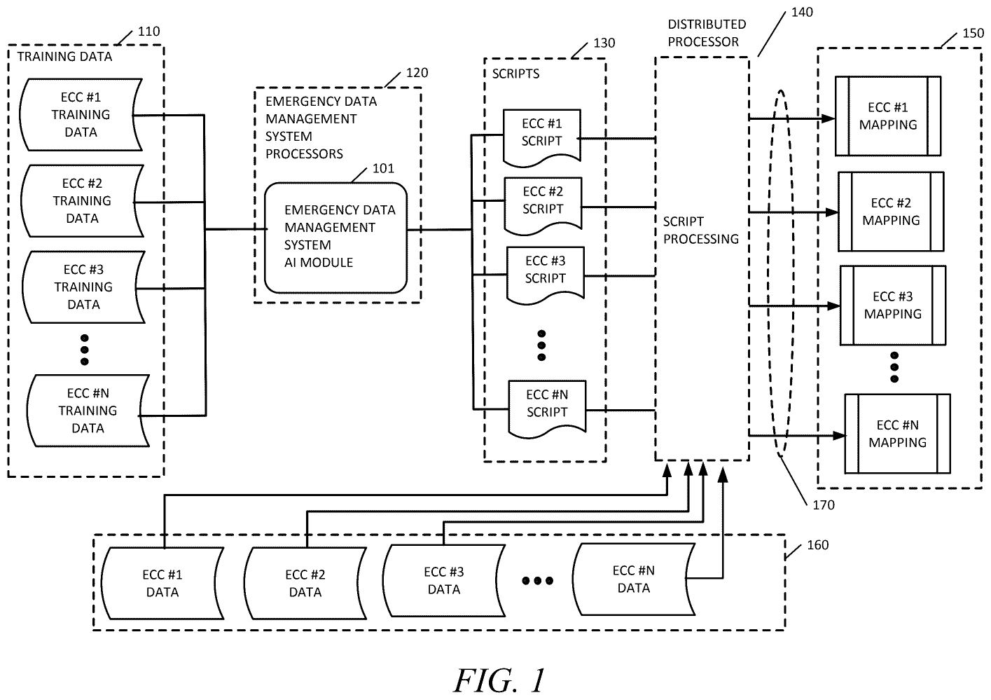

Turning now to the drawings wherein like numerals represent like components, FIG. 1 is a block diagram of a training scheme for an artificial intelligence module of an emergency data management system, in accordance with an embodiment. The artificial intelligence module 101 (AI module 101) implements a machine learning model, such as, for example, a large language model (LLM). The AI module 101 may also implement a deep learning model (such as an artificial neural network, or a convolutional neural network) and may utilize natural language processing (NLP). The AI module 101 is executed on one or more processors of an emergency data management system, i.e. emergency data management system processors 120. The emergency data management system (EDMS) may be a distributed system and may be cloud-based. Therefore, the EDMS processors 120 may be distributed processors. In one example embodiment, the EDMS provides various ECCs (Emergency Communications Centers) with one or more instances of a cloud-based application. Each cloud-based application instance provides a graphical user interface (GUI) referred to herein as an EDMS GUI. The EDMS GUI includes a map portion that presents various data to an ECC operator.

For machine learning training purposes, each ECC (ECC #1 through ECC #N) provides training data 110 for use by the EDMS AI module 101. The training data 110 consists of emergency call data received at the ECC, over a period of time, and includes emergency call data related to emergency alerts. The training data may include serial data such as, but not limited to, ANI/ALI data that is sent to the ECC whenever and emergency call is received at the ECC (i.e. a 9-1-1 call or 9-1-1 text message is received if the ECC is 9-1-1 text message capable). Regarding emergency alerts, the emergency alerts may be generated and provided by systems, apparatuses and methods such as those described in U.S. Pat. No. 11,749,094 issued Sep. 5, 2023 to Pellegrini et al.

The AI module 101 is trained for each ECC that provides training data, and produces an ECC script 130 as a result of the training. The production of the ECC script is a practical application in which the ECC script is used to configure a cloud-based processor (resident on a cloud-based server) and renders the cloud-based processor operative to perform specialized functions that it would not otherwise be capable of performing. The ECC script, when executed, extracts certain emergency data 160 and formats the emergency data 160 into a format useable by a mapping subprocess 150 of the cloud-based application, such that the cloud-based application can display the emergency data within the EDMS GUI map portion. The ECC scripts 130 may be executed by a distributed processor 140 in the cloud. The distributed processor 140 may be included in a virtual private cloud (VPC) infrastructure or other cloud infrastructure that is associated with the EDMS.

For example, the distributed processor 140 is operative to process each of the ECC scripts 130 (i.e. ECC #1 script through ECC #N script) to extract germane ECC data 160 and provide that ECC data 160 to the appropriate ECC mapping subprocess 150 for that ECC. Instances of the cloud-based application executing on machines at a specific ECC (i.e. workstations, etc.) may display the ECC data 160 with the EDMS GUI map portion.

In some embodiments, with respect to the example of FIG. 1, the AI module 101 is trained to perform a classification function on labeled data using a supervised learning approach and may be implemented using generative AI models. For example, in some embodiments, the AI module 101 may be trained on “ANI/ALI” data (i.e. “ANI” Automatic Number Identification and “ALI” Automatic Location Identification). However, in some embodiments, the AI module 101 may be trained on unlabeled data. The AI module 101 may be trained to extract ANI/ALI data and place it into a JSON (JavaScript Object Notation) formatted object in some embodiments. The JSON object may be an Emergency Incident Data Object (EIDO) in some embodiments. NENA defines an EIDO as “a JSON-based object that is used to share emergency incident information between and among authorized entities and systems.” Generative AI may be used to generate the various scripts, using for example, but not limited to, generative pre-trained transformers (GPT), bidirectional encoder representations from transformers (BERT), ELECTRA, XLNet, T5, and the like, etc.

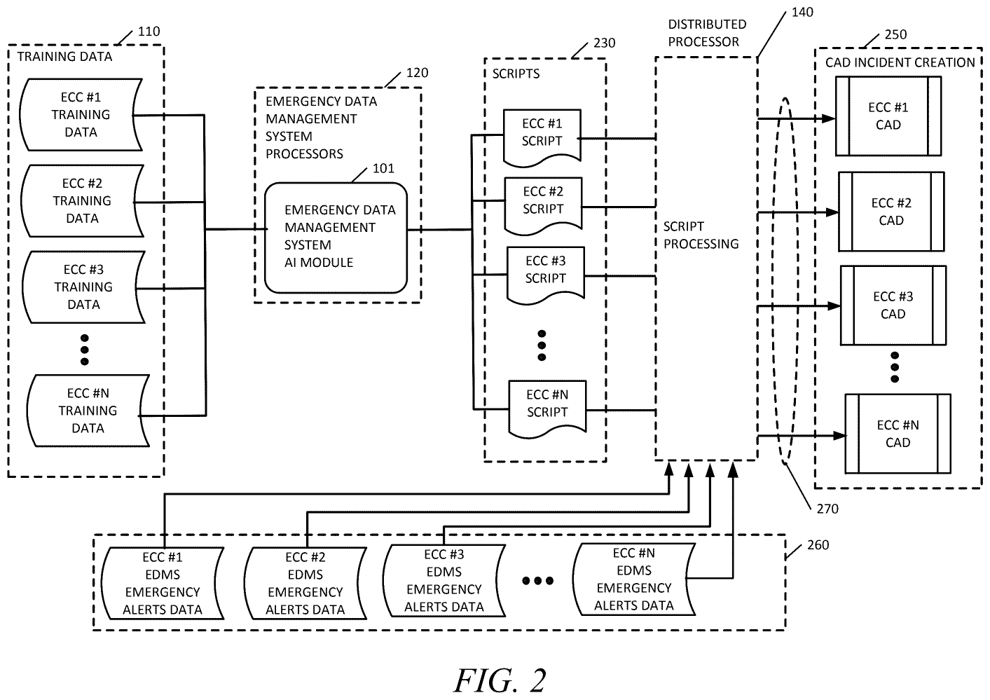

FIG. 2 is a block diagram of a training scheme for an artificial intelligence module of an emergency data management system, in accordance with another embodiment. In the embodiment example of FIG. 2, the AI module 101 is trained to create a CAD incident for EDMS emergency alerts data 260 that may be generated and provided by systems, apparatuses and methods such as those described in U.S. Pat. No. 11,749,094 issued Sep. 5, 2023 to Pellegrini et al. In some embodiments, the CAD incident created may be associated with a given class of service.

The AI module 101 is trained for each ECC that provides training data, and produces an ECC script 230 as a result of the training. The training data includes emergency call data (such as ANI/ALI data) from the ECC over a period of time. The ECC script 230, when executed, extracts data from EDMS emergency alerts data 260 and formats the EDMS emergency alerts data 260 into a format useable to create a CAD incident by CAD incident creation subprocess 250, such that an ECC CAD system creates an associated CAD incident record for an EDMS emergency alert. The ECC scripts 230 may be executed by a distributed processor 140 in the cloud, such as a distributed processor included in a virtual private cloud (VPC) infrastructure or other cloud infrastructure that is associated with the EDMS 300.

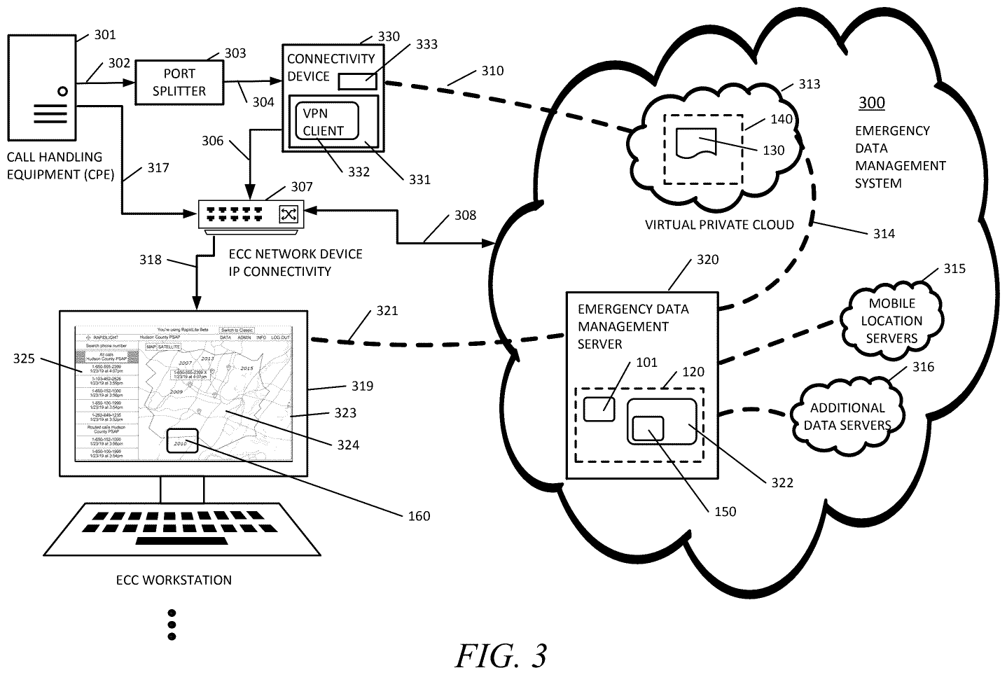

FIG. 3 is a block diagram of an Emergency Communication Center (ECC) that is in communication with a cloud-based, software-as-a-service (SaaS) emergency data management system (EDMS 300) that implements a script 130 as described with respect to FIG. 1, in accordance with an embodiment. The ECC may be a Public Safety Answering Point (PSAP). The ECC includes Customer Premises Equipment (CPE) 301 which is a set of communications or terminal equipment located in the ECC or PSAP facilities. In telecommunications, the acronym “CPE” may be defined as “customer-premises equipment” or “customer-provided equipment” and refers to any terminal and associated equipment located at a telephone system subscriber's premises and connected with a telephone carrier's telecommunication circuits at a demarcation point. The demarcation point established in a building or complex, or some specific location, separates the specific customer equipment (i.e. the ECC or PSAP equipment) from other equipment located in either the distribution infrastructure or central office of the communications service provider (such as a telephone carrier).

Examples of equipment that may be included in a CPE may include, but are not limited to, active equipment and devices such as telephones, routers, network switches, gateways, networking adapters and Internet access gateways that enable the ECC to access communication services and distribute them within an ECC local area network (LAN); or passive equipment such as analogue telephone adapters (ATA) or xDSL-splitters, including various telephone systems, private branch exchanges (PBXs) etc. Some of this equipment may be devices purchased by the ECC, however some may be provided by one or more service providers that provide telecommunications or other services to the ECC. The ECC CPE may have one or more racks or chassis to encase and hold the CPE equipment and to enable cabling and interconnection via various CPE-peripherals.

One specific example equipment in an ECC CPE is an Automatic Number Identification Controller (ANI Controller) which is defined by NENA as a “stand-alone CPE component which provides the ANI decoding and function key control for 9-1-1 service.” The ANI (Automatic Number Identification) refers to a telephone number (i.e. a “caller ID”) associated with the access line from which a call originates, and in legacy trunked telephony lines is transmitted to an ECC on a sideband channel transmitted on a trunked line. Assuming the system is operating properly, the ECC receives an ANI number associated with a 9-1-1 emergency call as it arrives.

Procedurally, an ECC then sends an “ALI Request” which is defined by NENA as a “query for an ALI record sent from the PSAP to the ALI database.” The ECC or PSAP may also perform “ALI Retrieval” which NENA defines as “the process by which a PSAP queries an ALI database with an ALI Request and receives a response with location and other available information.” The term “ALI” (Automatic Location Identification) is defined by NENA as “the automatic display at the PSAP of the caller's telephone number, the address/location of the telephone and supplementary emergency services information of the location from which a call originates.” The ANI and ALI data collectively may be referred to a “ANI/ALI” data.

Another specific example equipment in an ECC which may have one or more connections to the ECC CPE is a Computer Aided Dispatch (CAD) system. Nena defines CAD as “A computer based system, which aids PSAP Telecommunicators by automating selected dispatching and record keeping activities.” CAD systems are used to respond to a call for service (CFS) (also referred to as an “emergency call”) by creating a corresponding “incident” record, and dispatchers use the CAD system information to dispatch emergency responders to the incident address. A definition of the term “incident” is provided by APCO International. The Association of Public-Safety Communications Officials (APCO) International is the world's oldest and largest organization of public safety communications professionals, and generates standards related to public safety. One example APCO International standard is “Public Safety Communications Common Incident Types For Data Exchange,” APCO 2.103.2-2019. This standard defines the term “incident” as a “real world event such as a motor vehicle accident, structure fire or illness.” “Incidents may be declared by an ECC or by a unit reporting from the field.” Regarding CAD systems, the standard also defines an “incident type code” as “an acronym or other abbreviated combination of alphanumeric characters used to describe the nature of the real-world event that is being reported.” “Incident type codes typically differ between disparate ECCs and public safety agencies.”

CAD system operators are often referred to as “dispatchers” who operate a CAD workstation to dispatch emergency responders to the location of an emergency and manage vehicles and personnel. Depending on the size of an ECC, personnel may work as both call takers and dispatchers. In that situation an ECC operator may serve as a call taker and as a dispatcher and may have access to call taking software as well as CAD software. In larger metro areas, call taking is a separate function from dispatcher and when a call taker receives a CFS (i.e. emergency call) the call taker will communicate verbally with a dispatcher to convey information related to the emergency call. The dispatcher may then access the CAD software to create an incident and populate a specialized form selected to correspond the incident based on an incident type code as described in the APCO International standard discussed above.

This is a manual process and may be prone to errors in data entry by either the call taker/dispatcher or by a dispatcher receiving information verbally from a call taker. Additionally, each ECC may use its own incident forms and may require unique incident information specific for the particular ECC. CAD incident records may include hundreds of lines of textual information that includes some information manually entered by personnel, and some information populated from the call handling system such as the ANI/ALI data. The CAD system uses various types of data for various purposes. Each CAD incident form, that corresponds to an incident type having an incident type code as described in the APCO International standard discussed above, may include unique data specific to the incident type. For example, an “industrial accident” (incident code “ACCIND”) may have data related to an involved factory, machinery, hazardous materials involved or other related information. A medical emergency such as a “cardiac related event” (incident code CARDIAC) may have medical data related to the specific patient. Each incident code will have specific data related to that specific incident.

Another example of CAD system data is AVL data. CAD systems generally provide operators with a view to AVL data, (Automatic Vehicle Location data), and NENA defines AVL as “A means for determining the geographic location of a vehicle and transmitting this information to a point where it can be used.” More particularly, AVL data is information that is used the CAD system operators to track the location of vehicles, such as police cars, fire department vehicles, and ambulances, etc., in real-time.

AVL data may be generated by a Global Positioning System (GPS) or other location tracking systems that are installed within emergency responder vehicles. The AVL data may include, for example, a current location of a vehicle, as well as information about its speed, direction, and other information. A CAD workstation may display a map with layers of AVL data, among other layers, that therefore can be used to track the location and status of emergency responder vehicles in real-time, to provide dispatchers with information about the availability and location of resources, and to quickly see the location and status of all vehicles in the fleet. ECC dispatchers can thus use AVL information to make informed decisions about how to best deploy vehicles and personnel in response to emergency calls, alarms, etc. Reports and analytics may also be generated using AVL data, which can be used to improve the ECC operating efficiency and effectiveness, among other uses.

The ECC may obtain AVL data via a variety of networks, and emergency responder vehicles may for example, have an AVL system that is connected to a wireless modem or other device that is operative to transmit the data to the ECC over a wireless network. The wireless networks employed may be, but are not limited to: cellular networks including 5G networks, satellite networks, Wi-Fi networks, or ECC propriety wireless networks, etc. Intake of the AVL data by the ECC may then be through equipment located within the ECC CPE 301 that is connected to the ECC local area network (LAN).

The ECC also includes “call handling” which NENA defines as “a functional element concerned with the details of the management of calls.” According to NENA, call handling handles all communication from the caller and includes the interfaces, devices and applications utilized to handle the call. A “functional element” or “functional entity” is defined by NENA as “a set of software features that may be combined with hardware interfaces and operations on those interfaces to accomplish a defined task.” The ECC includes an APU (Answering Position Unit) which is defined by NENA as “a term used to define call-taking equipment.” The ECC workstation 319 shown in FIG. 3 may be referred to as an APU and is operatively coupled to the ECC LAN via connection 318 to the ECC network device 307. The ECC network device 307 may be, for example, a network switch or a router connected to backhaul 308 such as, for example, one or more T1 telecommunications lines or the like to provide Internet access and telephone network access to the ECC. The ECC network device 307 may be located within a rack of the CPE 301. Depending on the size of the ECC, multiple APUs such as ECC workstation 319 may be present at the ECC with each one operatively coupled to the ECC LAN and the Internet via a network connection 318 to the ECC network device 307 or to an internal ECC LAN switch or router, etc. Additionally, there may be separate APUs for call handling and CAD, or call handling and CAD software systems may be operating together on a single APU such as ECC workstation 319.

Calls received by the ECC come into the ECC via the CPE 301 and are internally switched or routed to an ECC workstation 319 (i.e. an APU) as appropriate per the specific ECC call handling operational procedures implemented by the CPE 301 and any intermediary call handling.

The term “call” as used herein comports with the NENA definition as “a generic term used to include any type of Request For Emergency Assistance (RFEA); and is not limited to voice.” Therefore, the term “call” may include a session established by signaling with two-way real-time media and involves a human making a request for help.” The terms “voice call”, “video call” or “text call” are used herein when the specific media is of significance. As per NENA definitions, the term “call” may refer to either a “voice call”, “video call”, “text call” or “data-only call”, since they are handled the same way through most of NG9-1-1.”

In the embodiment example shown in FIG. 3, a functional element of the CPE 301 is operatively coupled to a connectivity device 330. The connectivity device 330 includes several connection ports such that the connectivity device 330 is operative to connect to multiple functional elements. In some implementations, a port splitter may be employed, to enable a functional element to connect to multiple devices. In one example implementation of the FIG. 3 configuration, the functional element output may be connected to a port splitter 303 via a serial connection 302. Serial connection 302 may be a DB 9 or DB 25 type connection. A serial connection 304 may then be made between the port splitter 303 and the connectivity device 330 such that the serial connection 304 provides a serial data input to the connectivity device 330. In some embodiments, the functional element may be ANI Controller. In another embodiment the functional element may be an ANI Controller that is integrated into a call handling functional element. In yet another embodiment, the functional element may be an ANI modem bank that is operatively coupled to either a standalone ANI Controller or to an ANI Controller that is integrated into a call handling functional element. In any of these various implementations, the ANI Controller, whether standalone or integrated, and/or the ANI modem bank, may have a limited number of available serial ports. Therefore, the port splitter 303 may be used when needed to accommodate providing one or more additional serial ports. Therefore, in some embodiments the serial port splitter 303 may not be required.

Another functional element of the CPE 301 that may be operatively coupled to the connectivity device 330, and that may be connected to the port splitter 303 via a serial connection 302 in some embodiments, is a functional element that receives AVL data from an emergency responder vehicle fleet and that provides the AVL data to the ECC CAD system. In some embodiments, there may be two or more port splitters employed, for example, one port splitter connected to receive serial ANI/ALI data, and another port splitter connected to receive AVL data. Likewise, in some embodiments there may be more than one connectivity device 330 employed. For example, one connectivity device 330 may be used to receive serial ANI/ALI data, and another connectivity device may be used to receive serial AVL data. The connectivity device 330 includes serial-to-IP packet conversion capability such that it may convert received serial data to IP (Internet Protocol) packet data. The connectivity device 330 may also include IP ports and be operative to receive IP connections. For example, in some embodiments, the connectivity device 330 may have one or more Ethernet ports operative to connect to an IP device such as the ECC network device 307.

In the case of ANI/ALI data, either the port splitter 303 or an ANI Controller, Functional Element, etc., directly, provide a serial connection 304 for a serial data input to the connectivity device 330 which is operative to receive serialized data and convert it to packetized data for transmission over the Internet. The serial connection 304 may be a DB 9, a DB 25, or a USB connection. The connectivity device 330 is operatively coupled to the ECC network device 307 via a connection 306 which may be, for example an Ethernet cable. The ECC network device 307 provides the backhaul 308 connections to the Internet. In some embodiments, the connectivity device 330 may connect to the functional entity, related to receiving ANI/ALI data, via an IP connection (i.e. such as via an Ethernet cable connection to an Ethernet port).

The connectivity device 330 includes at least one processor 331, and non-volatile, non-transitory memory 333 that is operative coupled to the processor 331. The connectivity device 330 is operative to establish an IP connection 310 with the emergency data management system 300 (EDMS 300). In some embodiments, the memory 333 may include software operative to implement a virtual private network (VPN) client (VPN client 332) and to establish a VPN connection, over IP connection 310, with a virtual private cloud (VPC) network 313 associated with the cloud-based emergency data management system 300. In some embodiments, the VPN client 332 may be stored in the memory 333 as executable code. Further, an authentication procedure, authentication tokens and login credentials may also be stored in memory 333. In some embodiments, object-oriented programming code may be stored for execution by the processor 331.

In some embodiments, the EDMS 300 may include one or more VPC (virtual private cloud) networks 313 which are virtual networks with each virtual network being operatively coupled via network coupling 314, to the EDM server 320 and dedicated to the use of a single ECC within the public cloud computing environment of the internet. A VPC network 313 may be used to provide the ECC with a high level of isolation from other ECCs accessing the emergency data management system 300 and also provide the ability to customize the network configuration to meet the ECC specific requirements. Therefore, a VPC network 313 can be used to host resources such as virtual machines, storage systems, and other resources, and allow the ECC to have a customized network environment within the public cloud, including the ability to create subnets, define network access controls, and configure security measures, while also providing the benefits of a public cloud such as scalability and flexibility while enabling the ECC to maintain a private and secure network environment.

In some embodiments, a VPN connection is established as a client-server configuration where the connectivity device 330 executes a VPN client 332 on processor 331 and a VPC network 313 of the emergency data management system 300 implements a VPN server having at least one processor 140, which may be a distributed processor. However, in other embodiments, a VPN may be implemented as a clientless VPN.

In the embodiments employing a client-server VPN implementation, the connectivity device 330 is operative to store executable code for the VPN client 332 in onboard memory 333 and to execute the VPN client 332 on processor 331 such that, upon establishing a connection to the Internet (using the backhaul 308 and IP connection 310), the VPN client 332 will initiate and establish a VPN connection with the VPC network 313 and the EDMS 300. The VPN client 332 sends data through the IP connection 310, via a VPN connection to a VPN server in the VPC network 313 which receives and processes the data on behalf of the VPN client 332. The VPN client 332 and VPN server then work together to create a secure and encrypted connection VPN connection (over IP connection 310) between the connectivity device 330 and the VPC network 313. The connectivity device 330 may then send data to a data endpoint within the VPC network 313 such as ANI/ALI data, or CAD AVL data, other CAD data, etc.

A VPN connection established by the connectivity device 330 may be, for example, an IPsec (Internet Protocol Security) secure network protocol suite connection. The IPsec protocol suite provides security for internet communication at the network layer by establishing a secure, encrypted connection between two devices, such as computers or routers, over the internet. IPsec consists of two main components; an Encapsulating Security Payload (ESP) and an Authentication Header (AH).

The ESP is used for encrypting and authenticating the data that is transmitted between the two devices and provides confidentiality, integrity, and authenticity of the data. The AH is used for authenticating the sender and the integrity of the data transmitted. However, the AH does not provide confidentiality, as this data is not encrypted.

IPsec can operate in two different modes, transport mode and tunnel mode. In transport mode, the IPsec security protocols are applied to the payload of an IP packet being transmitted, however the IP header is not encrypted or authenticated. In tunnel mode the entire IP packet, including the IP header and payload, is encrypted and authenticated. The encrypted IP packet is then encapsulated in a new IP packet and transmitted over the internet. Therefore, in the various embodiments, IPsec is used to secure a virtual private network (VPN) connection as described further herein to protect against various cyber threats such as, for example, man-in-the-middle attacks and data interception by hackers.

In some embodiments, the VPN connection may support IPv6 however the VPN connection may use IPv4 or IPv6. A VPC may include an identification and authentication function which provides an authenticated and labeled output to a data endpoint. In some embodiments, the identification and authentication function is program logic operative to add an ECC identifier to packet data received over a VPN connection from the connectivity device 330, and to perform an authentication process to reliably identify the ECC and a data endpoint which is an entity requesting access data or services. A VPC network 313 may be operative to implement a VPN server from the perspective of the connectivity device 330 which implements the VPN client 332.

In the various embodiments, an ECC identifier may be a unique identifier, or may include, or be a combination of, various source and destination variables such as, but not limited to, a Media Access Control (MAC) address, an IP address, a port number, an Ethernet frame, a network device identifier, hostname or domain name, etc. The ECC identifier, or components thereof, may be obtained partially or fully from the connectivity device 330, an ANI Controller, or another functional entity in the ECC CPE or may be another unique identifier unique to the ECC.

For example, a MAC address assigned to a network interface on a device such as the connectivity device 330, an ANI Controller, or another functional entity in the ECC CPE may be used. The MAC addresses may be 48 bits long expressed as a series of hexadecimal digits, separated by colons or hyphens. In another example, an IP address assigned to a device that is connected to the Internet such as, but not limited to, the connectivity device 330, an ANI Controller, or another functional entity in the ECC CPE may be used. An example IPv4 address is 32 bits long, expressed as a series of four decimal numbers, separated by dots, while an example IPv6 address is 128 bits long, expressed as a series of eight hexadecimal numbers, separated by colons. In another example, a port number is a 16-bit identifier that is used to identify a specific process or service on a device such as, but not limited to, the connectivity device, an ANI Controller, or another functional entity in the ECC CPE. The port numbers may be used in, as in IP networking practice, in combination with IP addresses to identify the endpoints of a communication session over a VPN connection. In another example, an Ethernet frame may be used where the Ethernet frame is a data packet used to transmit data over the ECC local area network (LAN). In this example, the Ethernet frame has a header that includes a destination MAC address of 48 bits length and a source MAC address of 48 bits length for a total of 96 bits length. In another example, a network device identifier of the connectivity device 330, an ANI Controller, or another functional entity in the ECC CPE may be used. These example network device identifiers are similar to the network device identifiers of devices such as switches and routers, etc. The length of these identifiers may vary, but they are at least 32 bits long. As noted above, the ECC identifier may be a combination of any of these examples and may either be, or include some other unique identification data.

The EDMS 300 may utilize a data endpoint which is an API endpoint and may be considered as the end of a communication channel between a functional entity at the CPE 301 and a VPC network 313. As mentioned above, the functional entity may be an ANI Controller, etc. In that context, the data endpoint may be considered an ANI/ALI API (application programming interface) endpoint which enables the connectivity device 330 to communicate with the VPC network 313. For example, a data endpoint, via an ANI/ALI API, may request resources from the connectivity device 330 over the IP connection 310.

In some embodiments, an identification and authentication function and a data endpoint, accessible by the EDMS 300 (for example via an API), may be operative to service multiple VPN connections where each VPN connection emanates from a different and distinct ECC having a unique ECC identifier. In such example embodiments, the identification and authentication function may be further operative to attach or insert the appropriate ECC identifier into packet data it receives over each VPN connection. In some embodiments, the connectivity device 330 is operative to attach or insert the ECC identifier.

In some embodiments, an identification and authentication function implements an Auth0 authentication between the connectivity device 330 and a data endpoint in the VPC network 313. In one example implementation, the connectivity device 330 can send an authentication request to a data endpoint, along with any necessary credentials for the ECC such as a username and password. The identification and authentication function will then verify the credentials and check whether the connectivity device 330 is authorized to access the data endpoint. If the connectivity device 330 is authorized, the data endpoint will send a response back to the connectivity device 330, indicating that the authentication was successful. In some implementations, the response may also include a token or other information that the connectivity device 330 can use to access the data endpoint in the future. If the connectivity device 330 is not authorized, then the identification and authentication function, on behalf of the data endpoint, will send a response back to the connectivity device 330, indicating that the authentication was unsuccessful. The connectivity device 330 may then need to try again with different credentials.

In some embodiments, an ANI/ALI API at a data endpoint may be a RESTful API in which each ECC connectivity device 330 (and the VPN client 332 if used) may represent an endpoint from which the data endpoint can obtain ANI/ALI data. The ANI/ALI API therefore may define at least one URL endpoint with a domain, port, path, and/or query string and within these definitions will be a unique ECC identifier. The VPC network 313 endpoints may be defined via IPv4 addresses (and ports) or via IPv6 addresses (and ports).

Thus, in some embodiments, a cloud-based data endpoint provides data, such as ANI/ALI data, to the EDMS 300 which may include one or more virtual servers, hardware servers, etc. as required to provide an Saas (software-as-a-service) capability to the various ECCs such as a cloud-based application 322. The EDMS 300 provides a web portal graphical user interface (GUI), EDMS GUI 323, to one or more ECC workstations 319 of multiple ECCs. Each EDMS GUI 323 executed on an ECC workstation corresponds to an instance of the cloud-based application 322 provided by the EDMS 300. The cloud-based application 322 instance may be run in a browser executed by the workstation 319 and using a web socket connection over an IP connection 321. The web socket connection may be established as a persistent connection and run over the top of a TCP (Transmission Control Protocol) connection. The cloud-based application 322 is executed by a processor 120 of the EDMS 300. The processor 120 may be a distributed processor in some embodiments. The processor 120 is also operative to execute the artificial intelligence (AI) module 101.

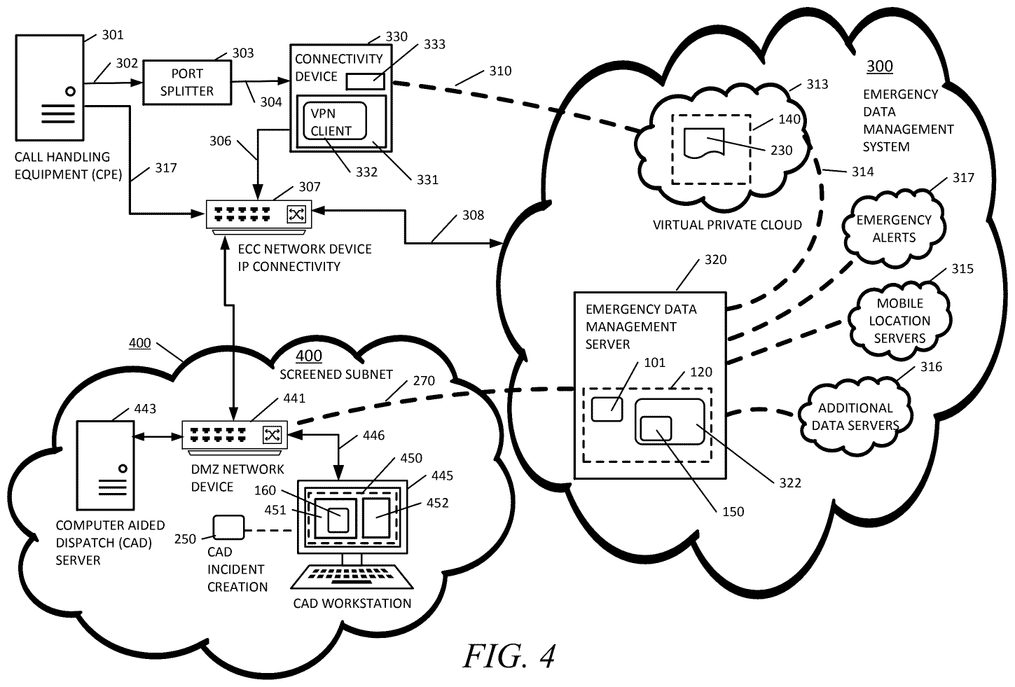

The EDMS GUI 323 provides a map view 324 with location indicators and other data corresponding to emergency calls directed to the ECC (whether call routing is completed or not) and a call queue 325 with ANI (called ID) data for each call, in addition to other data such as ADR (additional data repository) data, medical data, etc. from the additional data servers 316. The map view 324 also includes the emergency data 160, obtained by the connectivity device 330 from an ECC functional entity, and sent to the VPC network 313, in accordance with an embodiment. The data 160 may be also be related to an ECC CAD incident form information for given CAD incident types. The implementation for providing output data 270 to a CAD system is described below with respect to FIG. 4.

The EDMS 300 is operative to receive mobile device location data, and other emergency data, from various mobile location servers 315 and from additional data servers 316. The EDMS 300 is also operative to receive emergency alerts from various emergency alert systems 317 such as those described in U.S. Pat. No. 11,749,094 issued Sep. 5, 2023 to Pellegrini et al. Such emergency alerts may include, but are not limited to, home security alarms (which may include burglar alarms, fire alarms or other types of alarms), alarms for commercial buildings and institutions (which may also include burglar alarms, fire alarms, hazard alarms, etc.), medical bracelets, medical devices, etc. The mobile location servers 315 receive hybrid location data from mobile devices via Internet connectivity to the mobile devices, and the data may include for example, but are not limited to, Android Mobile Location (AML) data, Android Emergency Location Service (ELS) data, and Hybridized Emergency Location (HELO) data provided by iOS™ devices, and other mobile device location data, etc. In some embodiments, the EDMS 300 uses the data from a cloud-based data endpoint to identify emergency location data and other data associated with device identifiers (i.e. ANI/ALI data) and can match up data from the cloud-based data endpoint with other available emergency data to provide more complete and accurate information to the ECCs. The match up of cloud-based data endpoint data with data received by the EDMS 300 enables identification of emergency calls that have been routed to the ECC via telephony routing. However, the EDMS 300 information is not limited to emergency calls that have been routed to the ECC and the data obtained from the mobile location servers 315, additional data servers 316, and emergency alerts systems 317 can be obtained by the EDMS 300 and provided to the EDMS GUI 323 prior to the ECC receiving and answering the call.

Therefore, EDMS 300 is operative to provide an emergency call queue 325 and a map view 324 on the EDMS GUI 323 that shows location indicators for devices from which emergency calls have emanated even before completion of the emergency call routing to the ECC. The EDMS 300 is also operative to display emergency data 160 on the map view. The emergency data may be, but is not limited to, ANI/ALI data, AVL data, etc. The ANI/ALI data may be used by the EDMS 300 to distinguish calls that have already been received by (i.e. routed to) the ECC and provide more detailed and useable data. The ANI/ALI data address, although often times not accurate and not used to actually dispatch emergency responders, is used as incident identification information in CAD incident records created in the ECC CAD system.

Because either a cloud-based identification and authentication function, or the connectivity device 330, adds an ECC identifier to data it receives, likewise the EDMS 300 identifies that data, using the ECC identifier to push related data for the specific ECC to an appropriate ECC workstation (i.e. and ECC workstation that belongs to the specific ECC) via the EDMS GUI 323.

The EDMS 300 may also determine which ECC should receive what data based on related mobile device location and whether a specific device that placed a call is located within an ECC geofence specified in a geofence database. Alternatively, where an ECC may not have a specified geofence in the geofence database, the EDMS 300 may use a reference source such as, but not limited to, a NENA PSAP Database Tool, for example the Enhanced Public Safety Answering Point (PSAP) Registry and Census (EPRC), which is a secure web-based tool that was developed in 2019 and which contains information for PSAPs throughout the United States.

The initial emergency call queue 325 of the EDMS GUI 323 may be displayed in various distinct colors, font styles, or using distinctive icons such that the call takers understand each entry in the queue and can also distinguish between incoming calls and calls that have been placed but not yet received.

As the EDMS 300 detects calls arriving at the ECC via data it receives from the connectivity device 330, or via the data it receives via the mobile location servers 315, the EDMS 300 can either change the call queue entry color, font style, or icon, etc. for queue entries related to calls that have been received by the ECC (or calls made but not yet routed or received at the ECC) such that the change appears on the EDMS GUI 323. For example, calls that have been received by the ECC will have data sent to the EDMS 300 from the connectivity device 330.

In another implementation, the EDMS 300 can create a separate emergency call queue on the EDMS GUI 323 that is specific to the ECC workstation on which it is displayed. The specific emergency call queue can display, for example, only emergency calls related to device identifiers received by the specific workstation. The specific workstation, in some embodiments, may be identified by the emergency data 160.

Similarly, the map view provided by the EDMS GUI 323 may display location indicators for devices from which emergency calls have emanated before completion of the emergency call routing to the ECC differently than location indicators for emergency calls that have been received at the ECC. The EDMS GUI 323 may display location indicators in various distinct colors, using different font styles, or using distinctive icons such that the call takers understand each location point and can distinguish between incoming call locations and calls that have been placed from a location but not yet received at the ECC.

The map view 324 provided by the EDMS GUI 323 may also display AVL data using various distinct colors, using different font styles, or using distinctive icons. For example, different icons may be used for police, fire, medical, or other types of emergency responder vehicles. The location indicators and AVL indicators may be displayable in a layer format in which a user of the EDMS GUI 323 may turn layers on and off depending upon the operator's preferences or specific needs during handling a call or dispatch operations. The EDMS GUI 323 may also provide an indication that additional data is available, such as data that may be important for a specific CAD incident type. The emergency data 160 may be AVL data, ANI/ALI data, or a combination of both. The emergency data 160 may be displayed within a popup window that displays when the workstation 319 user hovers the mouse over a location indicator or other indicator associated with an emergency call displayed on the map view 324. Some or all of the emergency data 160 may be displayed within the call queue 325. In another alternative, the emergency data 160 may be displayed in a separate popup window that displays when the workstation 319 user selects an entry from the call queue 325.

The connectivity device 330 may send data to the EDMS 300 in a streaming manner, or as a data push operation, as the data is obtained by the connectivity device 330. In response to receiving data from the connectivity device 330 whether sent in a data stream, as a push operation, or as a data query made via the EDMS GUI 323 by a call taker/operator, the EDMS 300 provides, or returns in response to a query, emergency data which includes, but is not limited to, augmented device location information and other additional data. In some implementations, an ECC CAD system, such as shown in FIG. 4, will include an integration enabling the CAD system to query the EDMS 300 to obtain mobile location information. In that case, the mobile location information from the EDMS 300 is displayed within a data field of the CAD GUI 450 in addition to the ANI/ALI data. The dispatcher accessing the CAD GUI 450 can then use the mobile location information from the EDMS 300 to dispatch emergency responders to the correct location.

For handling data, the connectivity device 330 may use RESTful API HTTP methods such as GET, POST, PUT, and DELETE. However, the connectivity device 330 may use the POST method to send emergency data 160, which may include ANI/ALI data, AVL data, or both, or other data to the EDMS 300 to create or update a resource at a cloud-based data endpoint in the VPC network 313. When the connectivity device 330 sends a POST request to the cloud-based data endpoint, it will normally be accompanied by a payload of data that is used to create or update the resource on the data endpoint. In some embodiments, the data may be in the form of a JSON object. In some embodiment, the JSON object may be an EIDO (“Emergency Incident Data Object”). In some embodiments, the data may be in XML format. The connectivity device 330 may also use the PUT method to update an existing resource on the data endpoint. For example, the data endpoint may send ANI/ALI updates via PUT when a mobile device in an emergency call changes locations, or for AVL data when an emergency responder vehicle changes location, etc.

The EDMS 300 uses any of the RESTful API HTTP methods such as GET, POST, PUT, and DELETE to handle data with the connectivity device 330, and also to provide data 160 to the EDMS GUI 323 displayed on the ECC workstation 319.

In the example embodiment of FIG. 3, a distributed processor 140, which may be used to implement a virtual machine such as a virtual server within the VPC network 313, is configured using the ECC script 130. The distributed processor 140 executes the ECC script 130 generated in the example machine learning training process of FIG. 1, and by doing so provides the output 170 as a formatted object, such as a JSON object which may be an EIDO, and provides it to an ECC mapping subprocess 150 of the cloud-based application 322. The cloud-based application 322 is executed on the EDMS processors 120, which may be distributed processors and which may be resident on at least one EDMS server 320, which may be a distributed server.

The example embodiment of FIG. 4 executes the ECC script 230 generated in the example machine learning training process of FIG. 2, by executing the ECC script 230 on a processor 140, which may be a distributed processor implementing a virtual machine in some embodiments, within the VPC network 313, and provides the output as output data 270 to a CAD incident creation subprocess 250, to create a CAD incident displayed by the CAD GUI 450. The output data 270 may then be used to populate a CAD incident form 451.

In the example implementation of FIG. 4, the connectivity device 330, in some embodiments, may use a VPN to communicate with the CAD system screened subnet 400 and the EDMS 300. The ECC in FIG. 4 may be a Public Safety Answering Point (PSAP). In the FIG. 4 example implementation, the ECC includes a demilitarized zone (DMZ) also referred to a screened subnet 400. The screened subnet 400 includes the CAD system which further includes a CAD server 443, one or more CAD workstations 445, and at least one DMZ network device 441 which may be an internal router such as a choke router. In some ECC implementations, the ECC workstation 319 shown in FIG. 3 may have access to a CAD application provided by the CAD server 443, however a dedicated CAD workstation 445 may be used as shown in FIG. 4. In that case, the CAD workstation 445 may have restricted access to external websites and may be restricted to functions provided by the CAD server 443 with few exceptions. The CAD workstation 445 is operatively coupled to the screened subnet 400 via the DMZ network device 441 via connection 446. The DMZ network device 441 is operatively coupled to the ECC network device 307 to obtain restricted internet access and ECC network access.

In some implementations, the CAD workstation 445 will be enabled to access the EDMS 300 to display the EDMS GUI 323. However, in some ECC implementations, only the ECC workstation 319, which is isolated from the screened subnet 400, may access the EDMS GUI 323. The CAD workstation 445 displays a CAD GUI 450 which accesses a CAD application provided by the CAD server 443 in the DMZ. The CAD operator uses a CAD incident form 451 provided by the CAD GUI 450, to input CAD incident information. The CAD GUI 450 also provides a notes field 452 which accompanies, or is integrated with, the CAD incident form 451. Each CAD incident type will have a corresponding CAD incident form 451 that may also correspond to an incident type having an incident type code as described in the APCO International standard discussed above.

In accordance with the embodiments, the connectivity device 330 is operative to establish a connection to the screened subnet 400 to send data from the EDMS 300 to the CAD server 443. The EDMS 300 may include the machine learning AI module 101 executed by a processor 120 of the EDMS 300, where the AI module 101 is operative to generate the ECC script 230 specific to the ECC being served as discussed with respect to FIG. 2. The ECC script 230, when executed, is operative to receive EDMS emergency alerts data use data 260 received by the EDM server 320 from the emergency alerts systems 317 and provide the output data 270 which is in a format for use by a CAD incident creation subprocess 250. In some embodiments, the EDM server 320 may also insert additional data into the emergency alert data received from the emergency alerts systems 317, prior to the ECC script 230 processing it and sending it to the ECC as output data 270.

In one example, the ECC script 230, when executed by processor 140, may receive emergency alerts data from emergency alerts systems 317, where the emergency alerts data corresponds to emergency alerts generated and provided by systems, apparatuses and methods such as those described in U.S. Pat. No. 11,749,094 issued Sep. 5, 2023 to Pellegrini et al. The ECC script 230 may select an appropriate class of service based on the AI module 101 training used to generate ECC script 230. Class of service refers to a designation of the type of telephone service, for example, residential, business, PBX, wireless, VOIP, etc. Examples and recommended classes of service (CoS) are provided in “NENA Standard Data Formats For E9-1-1 Data Exchange & GIS Mapping,” NENA-STA-015.10-2018. Examples of the NENA recommended classes of service include, but are not limited to, residence, business, mobile, various voice-over-IP (VOIP) classes of service such as VOIP Residence, VOIP Business, etc.

Incoming ANI/ALI data received by an ECC contains class of service (CoS) information related to each incoming emergency call. The AI module 101 is trained to identity each data field for all of the possible CoS that may be received by an ECC. The AI module 101 is then trained to determine which of the possible CoS types has the largest number of data fields. The AI module 101 is then trained and programmed (or prompted) to build an ECC script 230 based on examples of emergency alerts that would be received by the EDM server 320 from various of the emergency alerts systems 317. The AI module 101 is programmed or prompted to generate the ECC script 230, such that is operative to format incoming emergency alert data, as output data 270, according to the CoS determined to have the largest number of data fields. Because all of the possible CoS are recognizable by the CAD incident creation subprocess 250, the output data 270 can be sent to the CAD server 443 and will be recognized by the CAD incident creation subprocess 250 and displayed in the CAD GUI 450 as an incoming emergency call for the given CoS. The CAD system operator can then proceed to utilize an appropriate CAD incident form 451 using the output data 270. In one specific example embodiment, the CoS having the largest number of data fields may be a VoIP (voice-over-Internet-Protocol) CoS and emergency alerts may be formatted according to a VOIP CoS for output data 270.

Based on the information contained in the output data 270 displayed to the CAD operator, the CAD operator may select an appropriate CAD incident type and CAD incident type code by assessing the output data 270 as emergency data associated with an emergency call. The EDM server 320, and cloud-based application 322, are operative to receive emergency alerts data from the emergency alerts systems 317, send it to the ECC script 230 processing (i.e. send it to processor 140) and processor 140 further is operative to send the output data 270, generated by the ECC script 230, to the connectivity device 330. In turn, the connectivity device 330 is operative to send the output data 270 to the CAD server 443 over a TCP connection. The output data 270 is then used to populate the relevant CAD incident form 451 and notes field 452 as required.

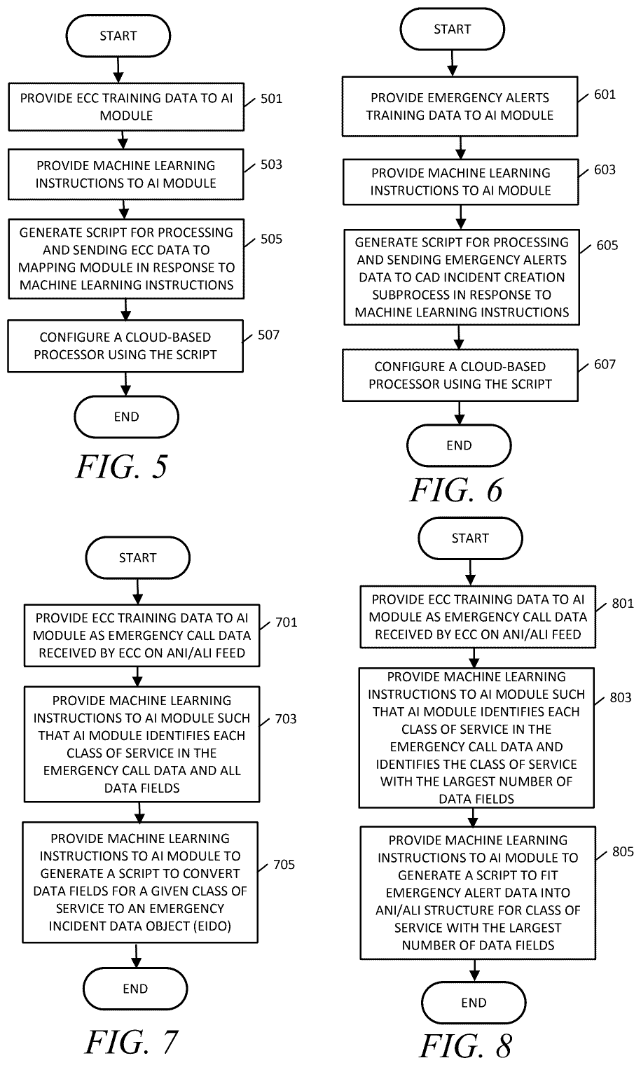

FIG. 5 is a flowchart of a method of operation for machine learning training in accordance with an embodiment corresponding to FIG. 1. At operation 501 ECC training data 110 is provided to the AI module 101. The ECC training data 110 may be serial output data from an ECC functional entity and may be, but is not limited to, ANI/ALI data. At operation 503, machine learning instructions are provided to the AI module 101. The AI module 101, may implement a large language model (LLM) in some embodiments. The machine learning instructions may be code, prompts or a combination of both. At operation 505, the AI module generates an ECC script 130 for processing and sending ECC data to a mapping subprocess 150 of the cloud-based application. The script is generated using machine learning and may be generated by generative AI. At operation 507, the ECC script is used to configure a cloud-based processor such that the cloud-based processor is operative to send ECC data to the mapping subprocess 150 to include the ECC data, such as, but not limited to, ANI/ALI data, within a map view 324 of an EDMS GUI 323.

FIG. 6 is a is a flowchart of a method of operation for machine learning training in accordance with an embodiment corresponding to FIG. 2. At operation 601 ECC training data 110 is provided to the AI module 101. The ECC training data 110 may be serial output data from an ECC functional entity and may be, but is not limited to, ANI/ALI data. At operation 603, machine learning instructions are provided to the AI module 101. The AI module 101, may implement a GPT such as a large language model (LLM) in some embodiments. In some embodiments, the AI module 101 may interface with a GPT via one or more application programming interfaces (API). The machine learning instructions may be code, prompts or a combination of both. At operation 605, the AI module generates an ECC script 230 for processing and sending EDMS emergency alerts data to a CAD incident creation subprocess 250 of the ECC CAD system. The script is generated using machine learning and may be generated using generative AI. At operation 607, the ECC script 230 is used to configure a cloud-based processor such that the cloud-based processor is operative to send emergency alerts data to the CAD incident creation subprocess 250 such that an incoming incident is received by the CAD system.

FIG. 7 is a is a flowchart of a method of operation for machine learning training in accordance with an embodiment corresponding to FIG. 1. At operation 701 ECC training data 110 is provided to the AI module 101 where the ECC training data is serial ANI/ALI data output from an ECC functional entity. At operation 703, machine learning instructions are provided to the AI module 101 to identify each class of service and all data fields. The AI module 101, may implement a large language model (LLM) in some embodiments. The machine learning instructions may be code, prompts or a combination of both. At operation 705, the AI module is given instructions generate a script to convert data fields for a given class of service to an incident data object (EIDO).

FIG. 8 is a is a flowchart of a method of operation for machine learning training in accordance with an embodiment corresponding to FIG. 2. At operation 801 ECC training data 110 is provided to the AI module 101. The ECC training data 110 may be serial output data from an ECC functional entity and may be, but is not limited to, ANI/ALI data. At operation 803, machine learning instructions are provided to the AI module 101. The AI module 101, may implement a large language model (LLM) in some embodiments. The machine learning instructions may be code, prompts or a combination of both. The machine learning instructions instruct the AI module 101 to identify each class of service (CoS) present in the ECC training data 110 and also identify the CoS having the largest number of data fields. At operation 805, the AI module is provided with machine learning instructions to generate a script to fit emergency alert data into an ANI/ALI structure for a CoS having the largest number of data fields.

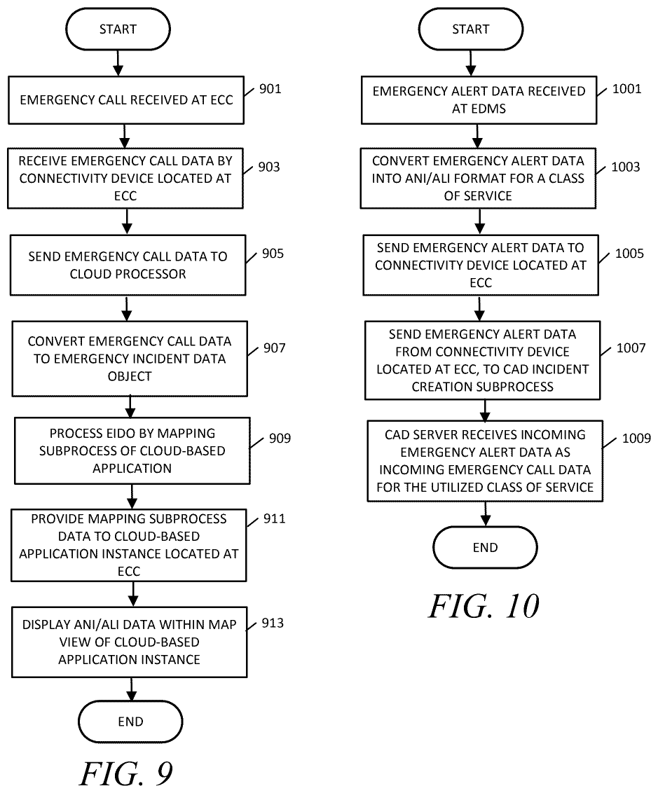

FIG. 9 is a is a flowchart of a method of operation for sending emergency data to an EDMS system in accordance with an embodiment corresponding to FIG. 3. At operation 901 an emergency call is received at the ECC, and at operation 903 the connectivity device 330 receives emergency call data from the ECC functional entity. For example, the connectivity device 330 receives ANI/ALI data over the serial connection 302. At operation 905 the connectivity device 330 sends the emergency call data to the processor 140 in the cloud, associated with the EDMS 300. At operation 907, the processor 140 executes ECC script 130 to convert the emergency call data into an Emergency Incident Data Object (EIDO). At operation 909 a mapping subprocess 150 of cloud-based application 322 receives and processes the EIDO, and at operation 911 the mapping subprocess data is provided to an instance of the cloud-based application 322 and the emergency data 160 is displayed within a map view 324 of an EDMS GUI 323 at operation 913.

FIG. 10 is a flowchart of a method of operation for sending emergency data to an ECC CAD system in accordance with an embodiment corresponding to FIG. 4. At operation 1001 EDMS emergency alert data 260 is received at the EDMS 300 from the emergency alerts systems 317. At operation 1003, the EDMS 300 executes the ECC script 230 to convert the EDMS emergency alert data 260 into ANI/ALI format for a CoS as output data 270. At operation 1005, the EDMS 300 sends the output data 270 to the connectivity device 330, and at operation 1007 the connectivity device 330 provides the output data 270 to the CAD screened subnet 400 and to a CAD incident creation subprocess 250. At operation 1009 the CAD server 443 (and CAD incident creation subprocess 250) receives the output data 270 and incoming emergency call data, incoming to the CAD system, for the utilized CoS. The output data 270 may be serial data such that it appears to the CAD system as the original ANI/ALI serial data feed would appear.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
training an artificial intelligence module in a cloud-based emergency data management system using training data comprising emergency call data from an emergency communication center (ECC);
generating a script, in response to the training data, by the artificial intelligence module, the script for converting emergency call data into a mapping subprocess format of the cloud-based emergency data management system; and
configuring a cloud-based processor using the script.

2. The method of claim 1, further comprising:
training the artificial intelligence module using training data comprising serial text data.

3. The method of claim 1, further comprising:
training the artificial intelligence module using ANI/ALI (Automatic Number Identification/Automatic Location Identification) data.

4. The method of claim 1, further comprising:
training the artificial intelligence module using AVL (Automatic Vehicle Location) data.

5. The method of claim 1, further comprising:
training the artificial intelligence module using call handling data.

6. The method of claim 1, further comprising:
training the artificial intelligence module to identify each class of service in the training data.

7. The method of claim 1, further comprising:
training the artificial intelligence module to identify each data field type in the training data.

8. A method of operating a cloud-based emergency data management system comprising:
obtaining emergency data related to an emergency call to an emergency communication center (ECC) by a connectivity device operatively coupled to a functional entity of the ECC;
sending the emergency data to a processor of the cloud-based emergency data management system;
converting the emergency data, by the processor, into a data object;
processing the data object by a mapping subprocess of a cloud-based application hosted by the cloud-based emergency data management system; and
updating a map view of an instance of the cloud-based application, executed on a computer located at the ECC, using the data object.

9. The method of claim 8, wherein obtaining emergency data, comprises:
obtaining serial text data via a serial port connection between the connectivity device and the functional entity.

10. The method of claim 8, wherein obtaining emergency data, comprises:
obtaining ANI/ALI (Automatic Number Identification/Automatic Location Identification) data from the functional entity by the connectivity device.

11. The method of claim 8, wherein obtaining emergency data, comprises:
obtaining AVL (Automatic Vehicle Location) data from the functional entity by the connectivity device.

12. The method of claim 8, wherein obtaining emergency data, comprises:
obtaining call handling data from the functional entity by the connectivity device.

13. The method of claim 8, wherein converting the emergency data, by the processor, into a data object, comprises:
executing a machine learning generated script by the processor, to convert the emergency data into the data object.

14. The method of claim 8, wherein converting the emergency data, by the processor, into a data object, comprises:
converting the emergency data, by the processor, into a javascript object notation (JSON) data object.

15. The method of claim 8, wherein converting the emergency data, by the processor, into a data object, comprises:
converting the emergency data, by the processor, into an emergency incident data object (EIDO).

16. The method of claim 14, wherein converting the emergency data, by the processor, into a data object, comprises:
executing a machine learning generated script by the processor, to convert the emergency data into a javascript object notation (JSON) data object.

17. The method of claim 15, wherein converting the emergency data, by the processor, into a data object, comprises:
executing a machine learning generated script by the processor, to convert the emergency data into an emergency incident data object (EIDO).

18. A system comprising:
a connectivity device, comprising at least one processor and a non-volatile, non-transitory memory, operatively coupled to the processor, the connectivity device located at an emergency communication center (ECC), operatively coupled to an ECC functional entity, and a cloud-based emergency data management system, the connectivity device operative to receive emergency call data from the ECC functional entity; and
the cloud-based emergency data management system, comprising:
at least a first cloud-based processor and a second cloud-based processor, the first cloud-based processor and the second cloud-based processor operatively coupled, the first cloud-based processor operative to:
receive the emergency call data from the connectivity device;
convert the emergency call data into a data object; and
send the data object to the second cloud-based processor;
the second cloud-based processor operative to:
receive the data object from the first cloud-based processor:
processing the data object by a mapping subprocess of a cloud-based application executed by the second cloud-based processor;
updating a map view of an instance of the cloud-based application, executed on a computer located at the ECC, using the data object.

19. The system of claim 18, wherein the connectivity device is further operative to:
receive the emergency call data as serial text data via a serial port connection between the connectivity device and the ECC functional entity.

20. The system of claim 18, wherein the connectivity device is further operative to:
receive the emergency call data as ANI/ALI (Automatic Number Identification/Automatic Location Identification) data from the ECC functional entity.

21. The system of claim 18, wherein the connectivity device is further operative to:
receive AVL (Automatic Vehicle Location) data from the ECC functional entity.

22. The system of claim 18, wherein the connectivity device is further operative to:
receive call handling data from the ECC functional entity.

23. The system of claim 18, wherein the first processor is further operative to:
execute a machine learning generated script to convert the emergency call data into the data object.

24. The system of claim 18, wherein the first processor is further operative to:
execute a machine learning generated script to convert the emergency call data into a javascript object notation (JSON) data object.

25. The system of claim 18, wherein the first processor is further operative to:
execute a machine learning generated script to convert the emergency call data into an emergency incident data object (EIDO).
